(19) United States
(12) Patent Application Publication
(10) Pub. No.: US 2007/0080050 A1
(43) Pub. Date: Apr. 12, 2007

(54) Safety switch structure with double protective effects

(76) Inventor: Jyh-Shyan Shiau, Tanizh Township (TW)

Correspondence Address: TROXELL LAW OFFICE PLLC, SUITE 1404, 5205 LEESBURG PIKE, FALLS CHURCH, VA, 22041, US

(21) Appl. No.: 11/497,411

(22) Filed: Aug. 2, 2006

(30) Foreign Application Priority Data
Oct. 12, 2005 (TW) 094217630

(51) Int. Cl. H01H 13/04

(52) U.S. Cl. 200/333

(57) ABSTRACT

A safety switch structure with double protective effects. The safety switch includes a base section having a main body formed with a first through hole and a second through hole. A surrounding wall outward protrudes from a first face of the main body from a periphery of the first through hole by a certain height. The surrounding wall is coaxial with the first through hole. The safety switch further includes a cover section including a cover board in alignment with an axis of the second through hole. The cover board has two rocking arms respectively rearward extending from two sides of a rear end of the cover board by a certain length. Each rocking arm has an extension end. The two rocking arms are respectively positioned on two sides of the surrounding wall. The safety switch further includes a pivot section disposed between the extension end of each rocking arm and the main body, whereby the cover section can be pivoted about an axis of the pivot section between a first position and a second position. The safety switch further includes an engaging section for locating the cover section in the second position.

### BACKGROUND OF THE INVENTION

The present invention is related to a safety switch, and more particularly to an improved safety switch structure with double protective effects.

Taiwanese Utility Model Patent No. 86209897 discloses a press switch structure having a cover board for covering the press key. In case of emergency, an operator can slap the cover board to trigger a stop key covered by the cover board so as to stop a machine from operating in time. When triggering the stop key, the hook legs of the switch main body are latched in the latch holes of the cover board to lock the cover board in a pressing position. When touching the activation key, the cover board is pivoted open and unlatched from the switch main body.

The above structure is able to achieve a certain protective effect. However, such structure still has some shortcomings as follows:
1. The cover board can totally cover the activation key and stop key of the switch to avoid danger. However, when it is necessary to press the activation key, an operator needs to first pivot open the cover board. This is quite inconvenient.
2. The cover board is locked by means of the hook legs and the latch holes. This enlarges the volume of the safety switch. As a result, the safety switch will occupy much room to affect the arrangement of the machine.

### SUMMARY OF THE INVENTION

It is therefore a primary object of the present invention to provide an improved safety switch structure with double protective effects. The safety switch can be conveniently used with safety ensured.

It is a further object of the present invention to provide the above safety switch structure which has minified volume.

According to the above objects, the safety switch structure with double protective effects of the present invention includes a base section having a main body formed with a first through hole and a second through hole. A surrounding wall outward protrudes from a first face of the main body from a periphery of the first through hole by a certain height. The surrounding wall is coaxial with the first through hole. The safety switch further includes a cover section including a cover board in alignment with an axis of the second through hole. The cover board has two rocking arms respectively rearward extending from two sides of a rear end of the cover board by a certain length. Each rocking arm has an extension end. The two rocking arms are respectively positioned on two sides of the surrounding wall. The safety switch further includes a pivot section disposed between the extension end of each rocking arm and the main body, whereby the cover section can be pivoted about an axis of the pivot section between a first position and a second position. The safety switch further includes an engaging section for locating the cover section in the second position.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a sectional view taken along line a-a of FIG. 2, showing that the cover section is positioned in the first position;

FIG. 4 is a sectional view taken along line a-a of FIG. 2, showing that the cover section is positioned in the second position;

FIG. 5 is a perspective exploded view of a second embodiment of the present invention;

FIG. 6 is a perspective assembled view of the second embodiment of the present invention;

FIG. 7 is a sectional view taken along line b-b of FIG. 6, showing that the cover section is positioned in the first position;

FIG. 8 is a sectional view taken along line b-b of FIG. 6, showing that the cover section is positioned in the second position;

FIG. 9 is a perspective exploded view of a third embodiment of the present invention;

FIG. 10 is a perspective assembled view of the third embodiment of the present invention;

FIG. 11 is a sectional view taken along line c-c of FIG. 10, showing that the cover section is positioned in the first position;

FIG. 12 is a sectional view taken along line c-c of FIG. 10, showing that the cover section is positioned in the second position;

FIG. 13 is a perspective exploded view of a fourth embodiment of the present invention;

FIG. 14 is a perspective assembled view of the fourth embodiment of the present invention;

FIG. 15 is a sectional view taken along line d-d of FIG. 14, showing that the cover section is positioned in the first position;

FIG. 16 is a sectional view taken along line d-d of FIG. 14, showing that the cover section is positioned in the second position;

FIG. 17 is a perspective assembled view of a fifth embodiment of the present invention;

FIG. 18 is a sectional view taken along line e-e of FIG. 17, showing that the cover section is positioned in the first position; and

FIG. 19 is a sectional view taken along line e-e of FIG. 17, showing that the cover section is positioned in the second position.

### DETAILED DESCRIPTION OF THE PREFERRED EMBODIMENTS

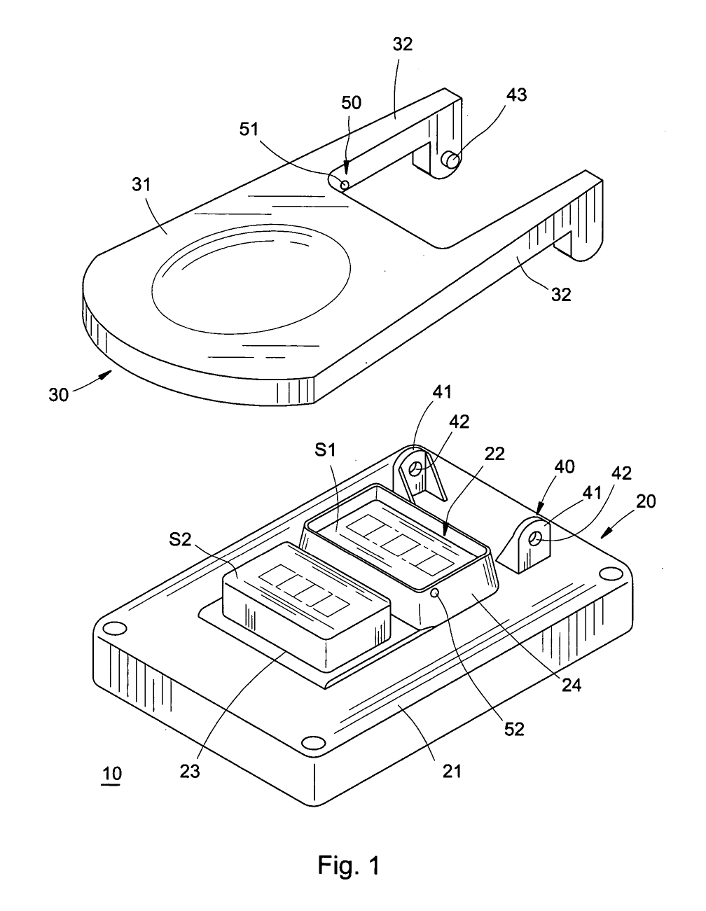

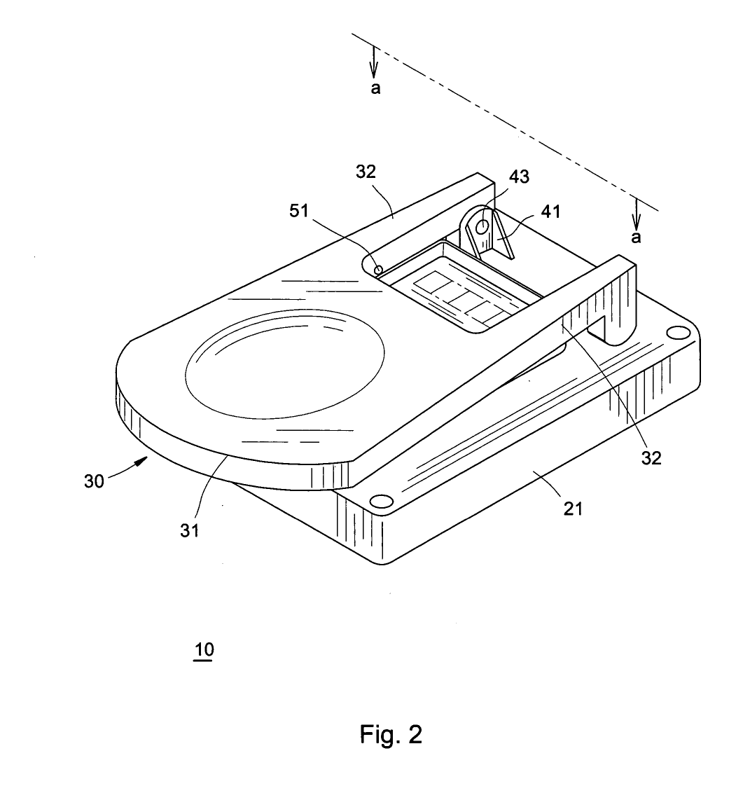

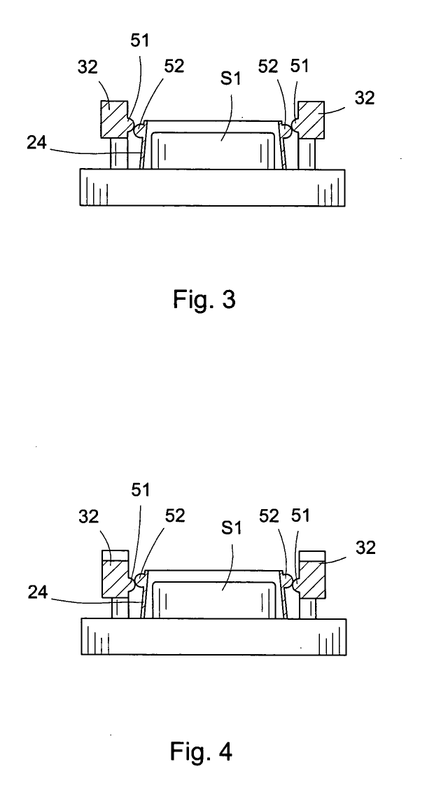

Please refer to FIGS. 1 to 4. The safety switch structure 10 with double protective effects of the present invention includes a base section 20, a cover section 30, a pivot section 40 and an engaging section 50.

The base section 20 has a rectangular board-like main body 21 formed with a first rectangular through hole 22 and a second rectangular through hole 23 passing through the main body 21 from a first face to a second face of the main body 21. A rectangular surrounding wall 24 outward protrudes from the first face of the main body 21 from a periphery of the first through hole 22 by a certain height. The surrounding wall 24 is coaxial with the first through hole 22.

The cover section 30 includes a cover board 31 in alignment with an axis of the second through hole 23. A first face of the cover board 31 faces the first face of the main body 21. The cover board 31 has two rocking arms 32 respectively rearward extending from two sides of a rear end of the cover board 31 by a certain length. Each rocking arm 32 has an extension end. A pivot boss 43 protrudes from an inner side of each extension end of the rocking arm 32. The two rocking arms 32 are respectively positioned on two sides of the surrounding wall 24.

The pivot section 40 includes a pair of pivot lugs 41 projecting from the first face of the main body 21. The pivot lugs 41 respectively have two pivot holes 42 coaxially aligned with each other. The two pivot lugs 41 are respectively positioned on the inner sides of the extension ends of the rocking arms 32 with the pivot bosses 43 coaxially pivotally fitted in the pivot holes 42. Accordingly, the cover section 30 can be pivoted about the axis of the pivot bosses 43 between a first position and a second position.

The engaging section 50 includes a first pair of dome-shaped engaging blocks 51 formed on the inner sides of the rocking arms 32. The engaging section 50 further includes a second pair of dome-shaped engaging blocks 52 formed on outer faces of two sides of the surrounding wall 24 corresponding to the first pair of engaging blocks 51. When the cover section 30 is positioned in the second position, the engaging blocks 51, 52 are engaged with each other to locate the cover section 30 in the second position.

An activation key S1 and a stop key S2 are respectively accommodated in the first and second through holes 22, 23. In case of emergency, an operator can slap the cover section 30 to pivot the cover section 30 from the first position to the second position. At this time, the cover board 31 presses the stop key S2 to open the circuit in time. At the same time, the cover section 30 is located in the second position by means of engaging the first pair of dome-shaped engaging blocks 51 with the second pair of dome-shaped engaging blocks 52. Before the cover section 30 is restored to the first position, even if S1 is pressed, the circuit remains opened.

The present invention is advantageous over the prior art in that:
1. The activation key S1 is not shielded by the cover section 30 to facilitate use of the safety switch.
2. The engaging section 50 is inbuilt in the original components of the switch without enlarging the volume of the switch. In addition, the engaging blocks can be conveniently disengaged from each other on purpose.

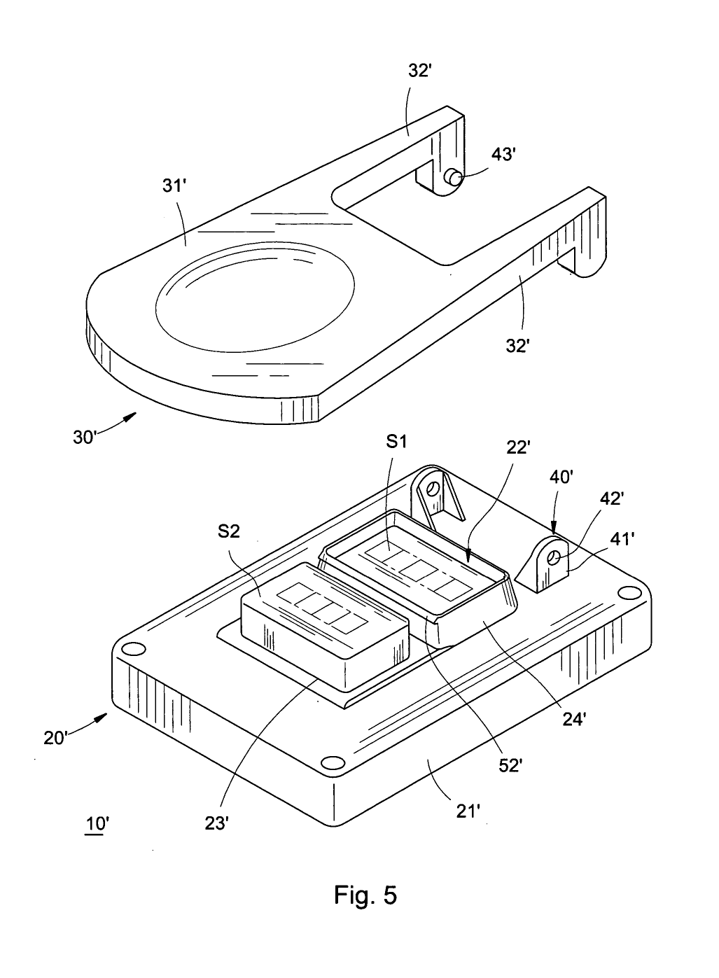

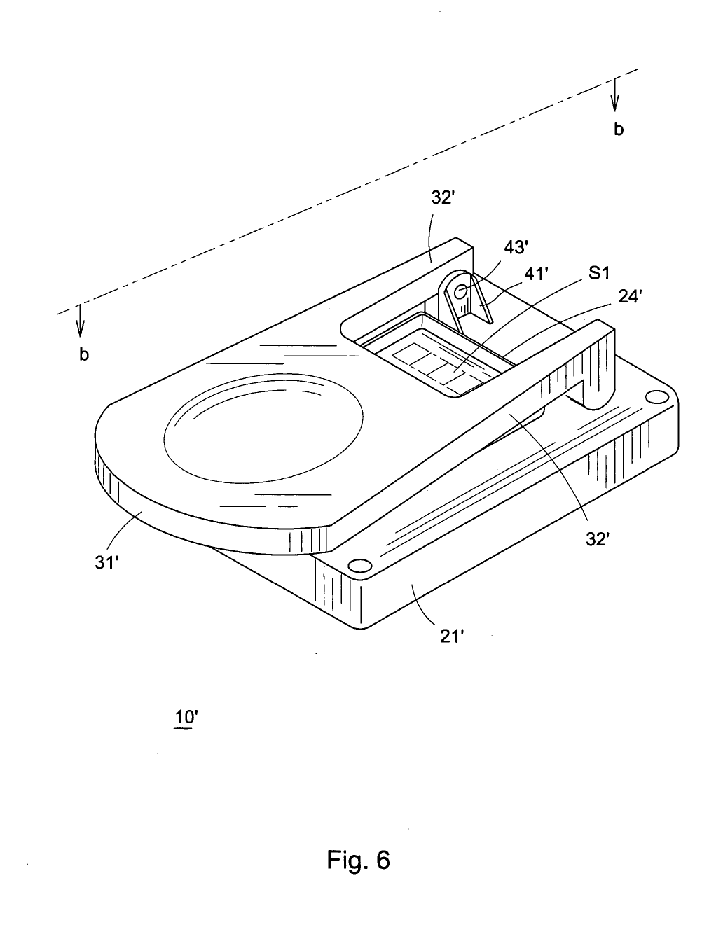

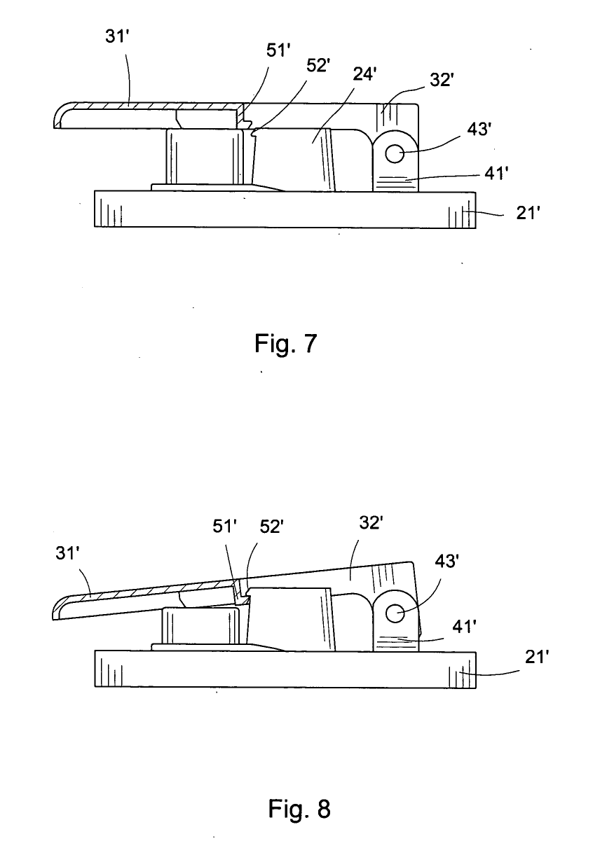

FIGS. 5 to 8 show a second embodiment of the safety switch structure 10′ with double protective effects of the present invention, in which the engaging section 50′ includes a first engaging rib 51′ formed on the rear end of the cover board 31 and a second engaging rib 52′ formed on front side of the surrounding wall 24′.

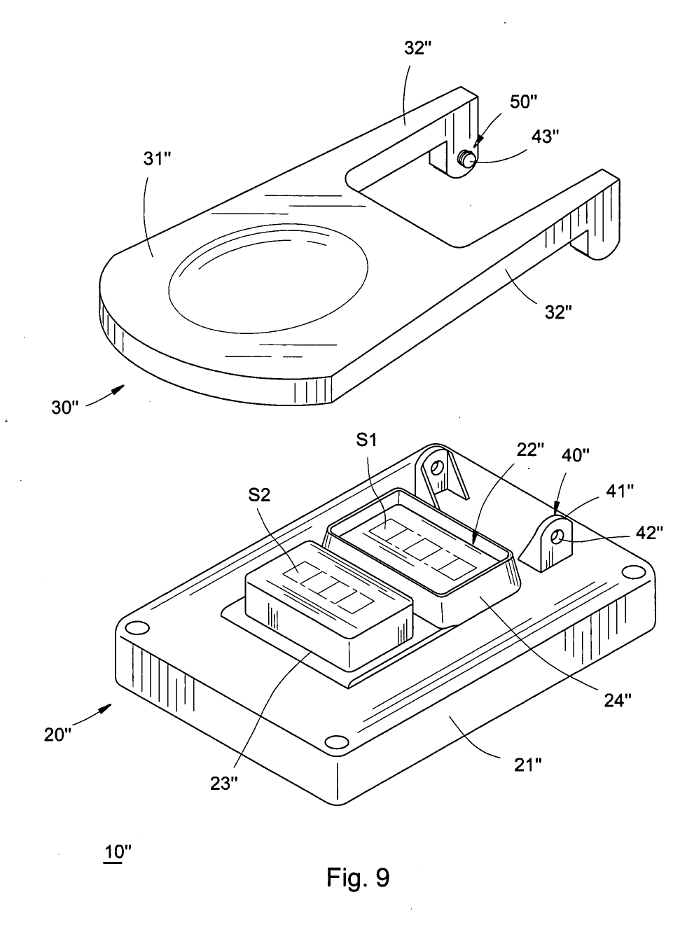

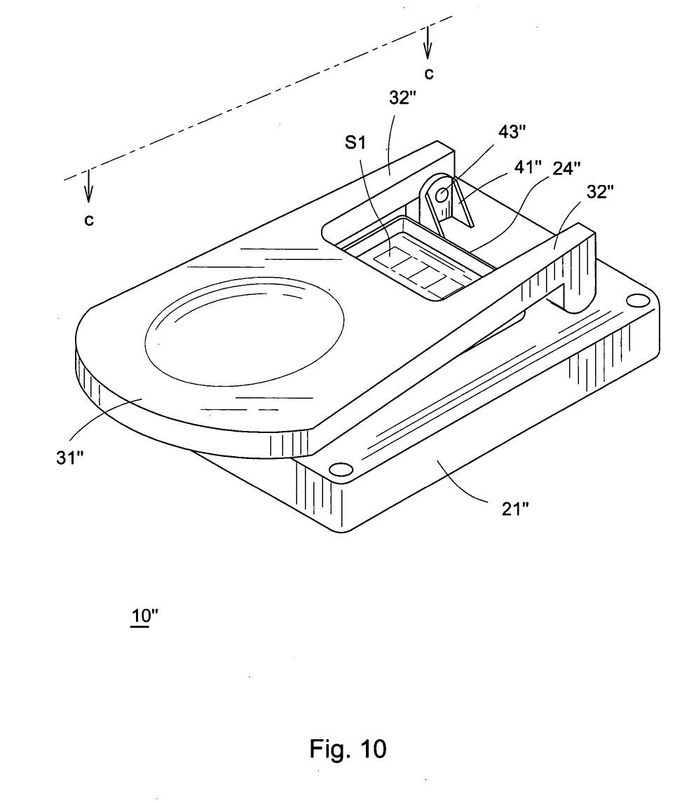

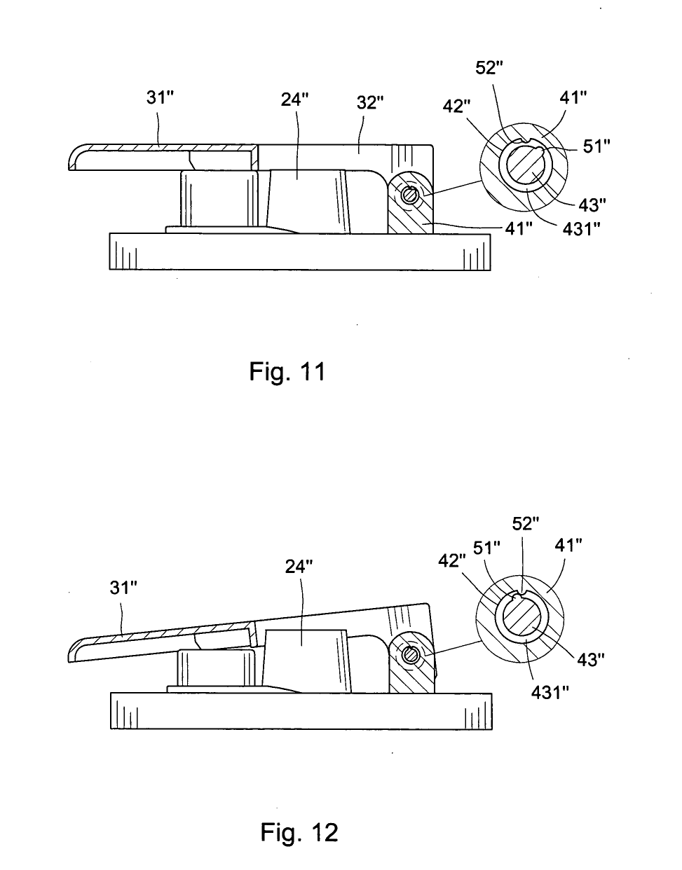

FIGS. 9 to 12 show a third embodiment of the safety switch structure 10′ with double protective effects of the present invention, in which each pivot boss 43″ is formed with an annular groove 431″. A dome-shaped engaging block 51″ protrudes from the bottom wall of the annular groove 431″. An engaging block 52″ protrudes from the circumferential wall of each pivot hole 42″. The engaging blocks 51″, 52″ can engage with each other to locate the cover board 31″.

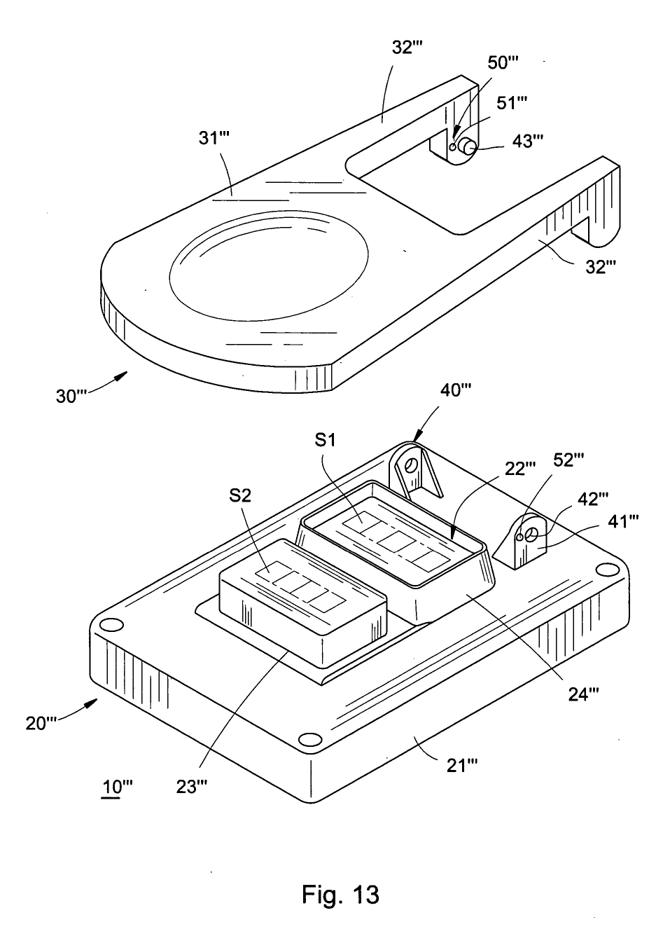

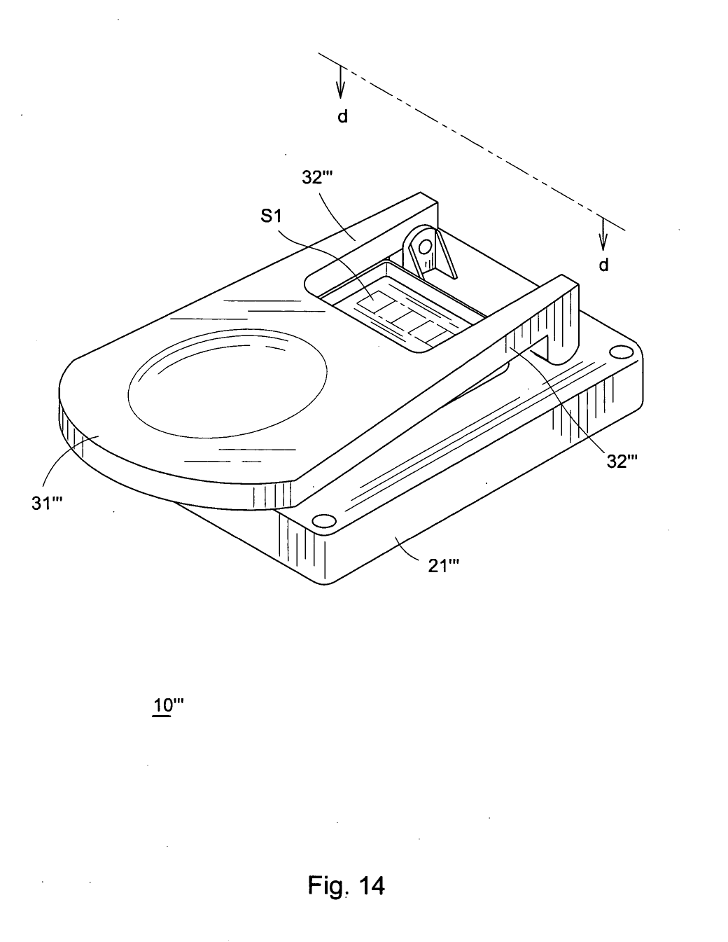

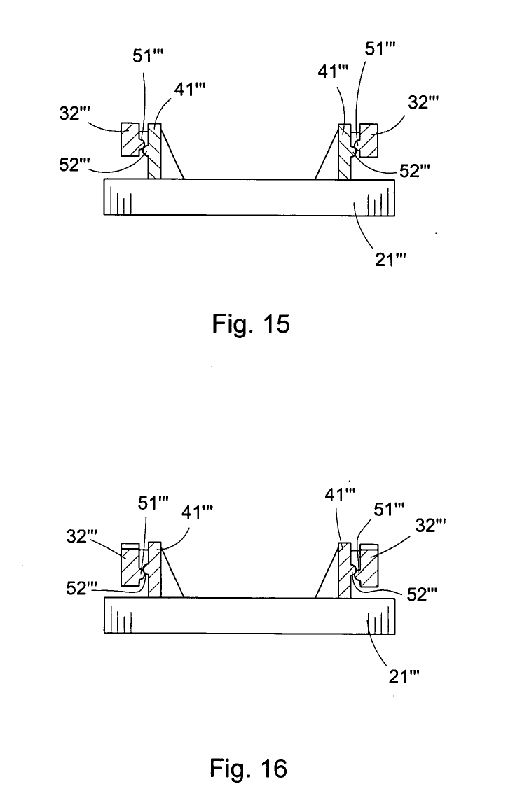

FIGS. 13 to 16 show a fourth embodiment of the safety switch structure 10′″ with double protective effects of the present invention, in which the dome-shaped engaging blocks 51′″, 52′″ are respectively formed on the opposite faces of the rocking arms 32′″ and the pivot lugs 41′″.

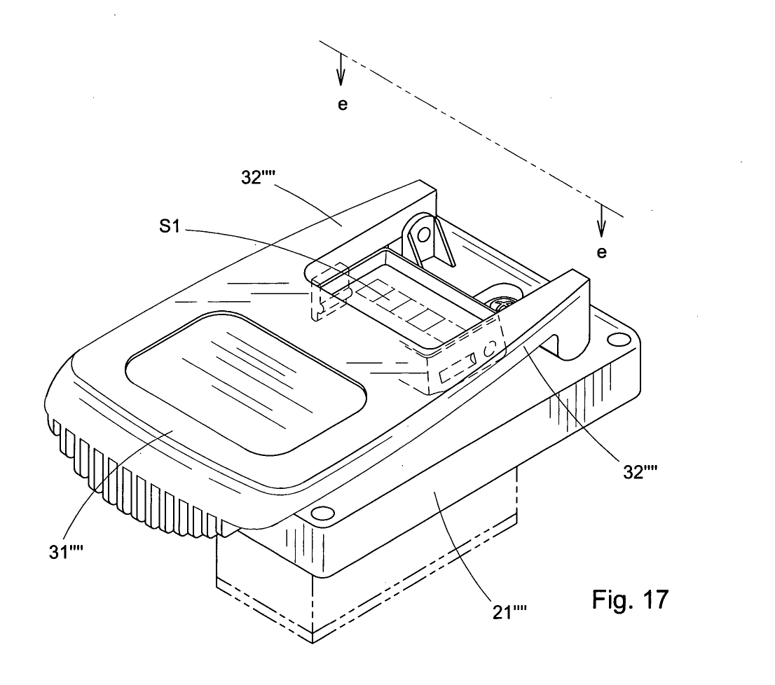

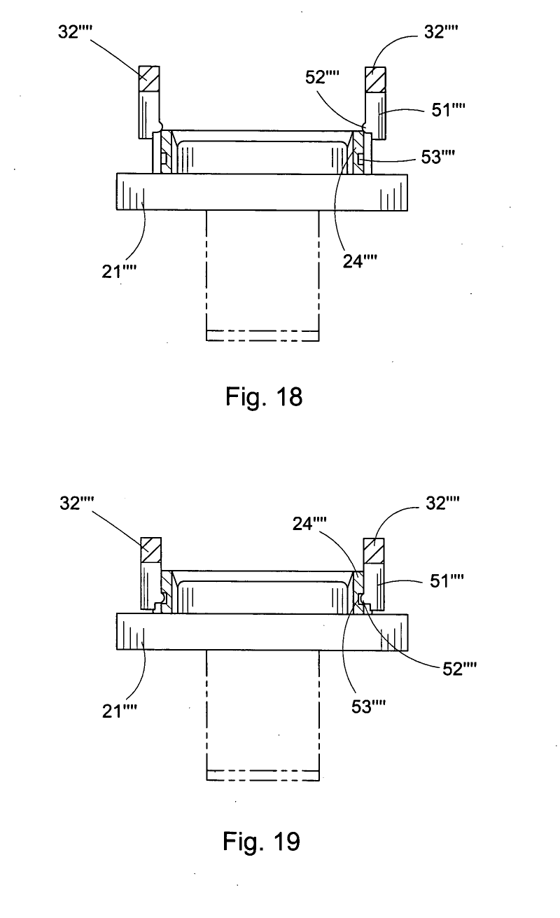

FIGS. 17 to 19 show a fifth embodiment of the safety switch structure 10″″ with double protective effects of the present invention, in which the engaging section 50′ includes two extension plates 51″″. The extension plates 51″″ respectively downward extend from lower sides of the rocking arms 32″″. Two transverse engaging ribs 52″″ are oppositely formed on the inner faces of the free ends of the extension plates 51″″. Two engaging grooves 53″″ are respectively formed outer faces of two sides of the surrounding wall 24″″. The engaging ribs 52″″ can be engaged in the engaging grooves 53″″ to locate the cover section.

Alternatively, the engaging section can include engaging blocks and engaging grooves complementary to each other. This can achieve an effect equivalent to that of the above embodiments.

It should be noted that the front end of the cover board forward protrudes from the main body. Accordingly, when the cover section is positioned in the second position, an operator can lift the front end of the cover board with a finger to disengage the first engaging blocks from the second engaging blocks.

The above embodiments are only used to illustrate the present invention, not intended to limit the scope thereof. Many modifications of the above embodiments can be made without departing from the spirit of the present invention.

What is claimed is:

1. A safety switch structure with double protective effects, comprising:
a base section having a main body formed with a first through hole and a second through hole passing through the main body from a first face to a second face of the main body, a surrounding wall outward protruding from the first face of the main body from a periphery of the first through hole by a certain height, the surrounding wall being coaxial with the first through hole;
a cover section including a cover board in alignment with an axis of the second through hole, a first face of the cover board facing the first face of the main body, the cover board having two rocking arms respectively rearward extending from two sides of a rear end of the cover board by a certain length, each rocking arm having an extension end, the two rocking arms being respectively positioned on two sides of the surrounding wall;
a pivot section disposed between the extension end of each rocking arm and the main body, whereby the cover section can be pivoted about an axis of the pivot section between a first position and a second position; and
an engaging section disposed between the cover section and the surrounding wall for locating the cover section in the second position.

2. The safety switch structure with double protective effects as claimed in claim 1, wherein the engaging section includes at least two engaging blocks respectively protruding from opposite faces of the cover section and the surrounding wall.

3. The safety switch structure with double protective effects as claimed in claim 1, wherein the engaging section includes engaging blocks and engaging grooves complementary to each other, the engaging blocks and engaging grooves being respectively disposed on opposite faces of the cover section and the surrounding wall.

4. The safety switch structure with double protective effects as claimed in claim 1, wherein with the cover section positioned in the second position, a front end of the cover board forward protrudes from the main body by a predetermined length.

5. A safety switch structure with double protective effects, comprising:
a base section having a main body formed with a first through hole and a second through hole passing through the main body from a first face to a second face of the main body, a surrounding wall outward protruding from the first face of the main body from a periphery of the first through hole by a certain height, the surrounding wall being coaxial with the first through hole;
a cover section including a cover board in alignment with an axis of the second through hole, a first face of the cover board facing the first face of the main body, the cover board having two rocking arms respectively rearward extending from two sides of a rear end of the cover board by a certain length, each rocking arm having an extension end, the two rocking arms being respectively positioned on two sides of the surrounding wall;
a pivot section disposed between the extension end of each rocking arm and the main body, whereby the cover section can be pivoted about an axis of the pivot section between a first position and a second position; and
an engaging section disposed on the pivot section for locating the cover section in the second position.

6. The safety switch structure with double protective effects as claimed in claim 5, wherein the pivot section includes a pair of pivot lugs projecting from the first face of the main body, the pivot lugs respectively have two pivot holes coaxially aligned with each other, the two pivot lugs being respectively positioned on the inner sides of the extension ends of the rocking arms, a pivot boss protruding from the inner side of each extension end of the rocking arm, whereby the pivot bosses are coaxially pivotally fitted in the pivot holes.

7. The safety switch structure with double protective effects as claimed in claim 6, wherein the engaging section includes engaging blocks and engaging grooves complementary to each other, the engaging blocks and engaging grooves being respectively disposed on the circumferences of the pivot bosses and the and the circumferential walls of the pivot holes.

8. The safety switch structure with double protective effects as claimed in claim 6, wherein the engaging section includes engaging blocks and engaging grooves complementary to each other, the engaging blocks and engaging grooves being respectively disposed on opposite faces of the pivot lugs and the rocking arms.

9. The safety switch structure with double protective effects as claimed in claim 5, wherein with the cover section positioned in the second position, a front end of the cover board forward protrudes from the main body by a predetermined length.
